(19) United States
(12) Patent Application Publication
(10) Pub. No.: US 2008/0172943 A1
(43) Pub. Date: Jul. 24, 2008

(54) Pivot lock for sliding windows

(75) Inventors: Joseph Famulare, Richmond Hill, NY (US); Eugene Orange, Richmond Hill, NY (US); Angelo Alfieri, Richmond Hill, NY (US)

Correspondence Address: COLLARD & ROE, P.C., 1077 NORTHERN BOULEVARD, ROSLYN, NY, 11576, US

(73) Assignee: Ultra Sash Window Factory, Inc.

(21) Appl. No.: 11/656,102

(22) Filed: Jan. 22, 2007

(51) Int. Cl. E05F 7/04

(52) U.S. Cl. 49/26

(57) ABSTRACT

A removable device can be placed into the groove of window frame of a sliding window and which prevents the window from pivoting inward during a storm. The device is a block having a top surface, a bottom surface a front face, a rear face, a leading end and a trailing end. The bottom surface of the block is configured to fit slidably within a window frame adjacent a sash within the window frame. The leading end of the block has a leg extending outward from the block so that when the block is positioned in the window frame so that the leading end abuts the window frame, the leg extends along a peripheral edge of the sash and prevents the sash from pivoting out of the window frame.

### BACKGROUND OF THE INVENTION

1. Field of the Invention

This invention relates to a lock that can be applied to a sliding window to prevent the window from pivoting open during high winds. In particular, the invention relates to a removable device that can be applied to a horizontal sliding window with a pivoting function, to lock the window in place and prevent the window from pivoting.

2. The Prior Art

Pivot locks for windows have been used in the past to prevent the windows from pivoting, either due to weather or due to intruders. One example is discussed in U.S. Pat. No. 6,363,659 to Wang. This patent describes an interlocking bracket system, where one bracket is mounted to the window sash and the other is mounted to the frame, and the brackets interlock to prevent the sash from pivoting outward. The brackets are permanently mounted to the sash and frame.

Another pivot lock is shown in U.S. Pat. No. 4,525,952 to Cunningham et al. This lock is built into the window sash, and is engaged by turning a handle on the sash, which causes a pivoting member to engage into a recess in the frame.

U.S. Pat. No. 5,103,589 to Crawford discloses another security assembly for sliding window sashes. This system is built into the window itself, and is formed from interlocking members of the window.

U.S. Pat. No. 5,560,149 to Lafevre discloses a storm resistant window having a latch that locks the sash to the frame.

While all of these devices serve the required purpose, they are all permanently attached to the window. It is desirable to have a removable device that can be put into place only when needed and which would prevent a sliding window from tilting inward during high winds.

### SUMMARY OF THE INVENTION

The invention relates to a removable device that can be placed into the groove of window frame of a sliding window and which prevents the window from pivoting inward during a storm.

The device comprises a block having a top surface, a bottom surface a front face, a rear face, a leading end and a trailing end. The bottom surface of the block is configured to fit slidably within a window frame adjacent a sash within the window frame. The leading end of the block has a leg extending outward from the block so that when the block is positioned in the window frame so that the leading end abuts the window frame, the leg extends along a peripheral edge of the sash and prevents the sash from pivoting out of the window frame. The leg preferably has a length approximately equal to a length of the block.

The block is preferably constructed from aluminum, but other materials, such as steel, composite or plastic could also be used.

The bottom surface of the block may have a downwardly extending leg and at least one flange on the leg that extends parallel to the top surface of the block. The flange keeps the block slidably mounted in the window frame when the block is placed in a window frame, because the flange fits under a lip in the window frame to keep the block from falling off.

The invention also includes a window assembly having a window in which the blocks are positioned. The window assembly has a window frame having an inner surface with a groove running all around the inner surface and two sashes slidably mounted in the groove of the window frame. The sashes are offset from one another in the window frame so that the sashes can slide independently of one another. There is at least one pivot lock such as a block described above, mounted in the groove adjacent an end surface of one of the sashes. Preferably there are two pivot locks, each located on opposite sides of the window frame.

The groove in the window frame preferably has at least one lip extending perpendicular to a longitudinal axis of the groove, and the bottom surface of the block has at least one flange extending parallel to the top surface of the block. The flange interlocks with the lip to keep the block securely and slidably mounted in the window frame. The flange can extend from a leg that extends downward from the bottom surface of the block.

In a preferred embodiment, the groove has an open area with no lip, so that the block can be removed from the window frame by sliding the block to the open area and removing the block from the frame.

The frame is generally installed so that the sashes slide in a horizontal direction, but a vertically oriented frame can be used as well.

The bottom surface of the block preferably has a cross-section that corresponds to a cross-section of the groove of the frame, so that the block fits exactly within the groove of the frame.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of a window assembly having two pivot locks installed thereon;

FIG. 2 shows a perspective view of a portion of the window assembly with the pivot lock installed thereon;

FIG. 3 shows a perspective view of a pivot lock according to one embodiment of the invention;

FIG. 4 shows a perspective view from another angle of the pivot lock according to FIG. 3; and

FIG. 5 shows a perspective view from yet another angle of the pivot lock according to FIG. 4.

### DETAILED DESCRIPTION OF THE PREFERRED EMBODIMENT

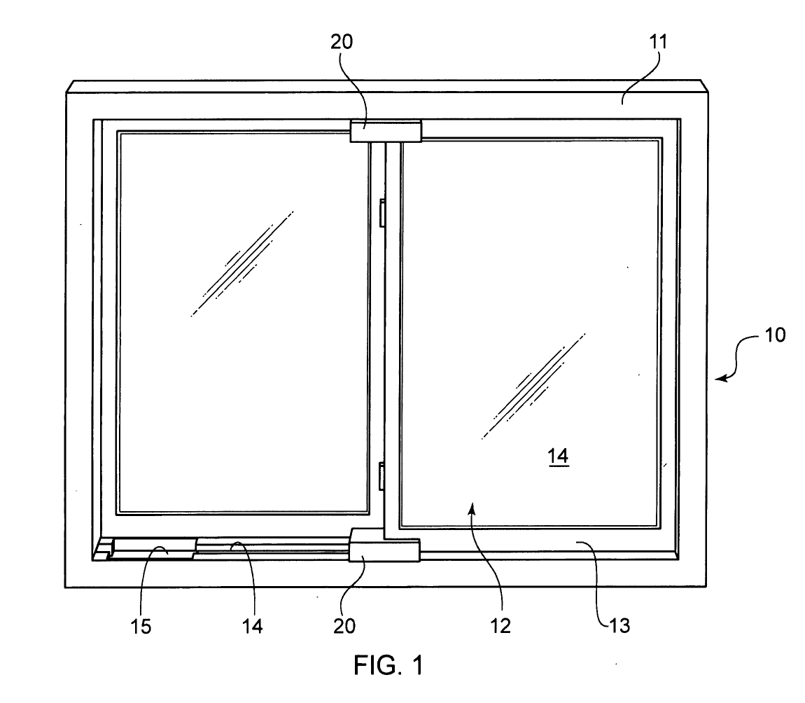

Referring now in detail to the drawings, FIG. 1 shows a view of a window assembly 10 according to the invention. Window assembly 10 comprises an outer frame 11, and two sliding sashes 12, each having an inner frame 13 and a pane 14. Sashes 12 are mounted so that they reside in a groove 14 of outer frame 11, and are offset from each other so that they slide independently of each other.

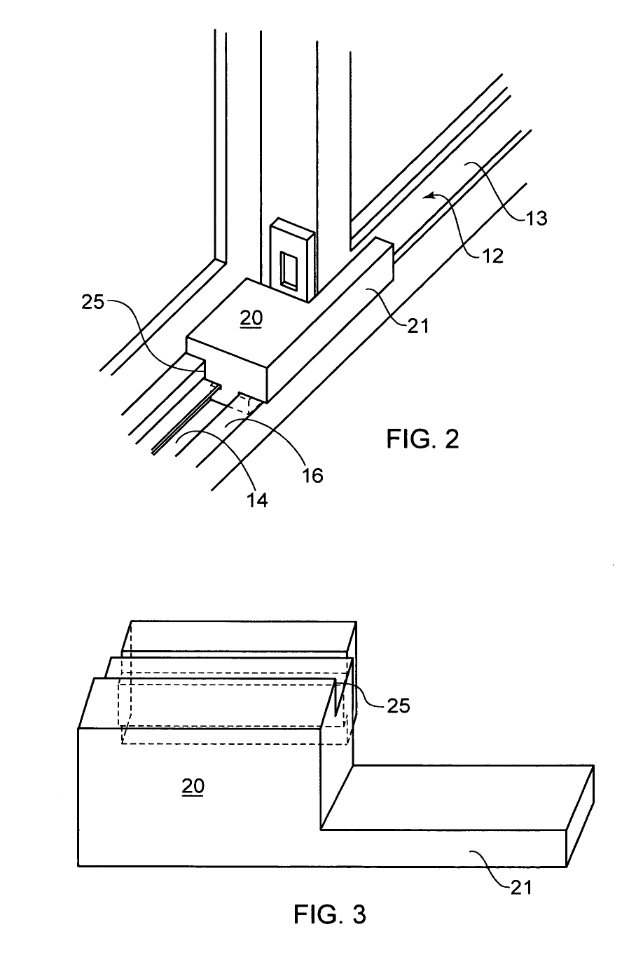

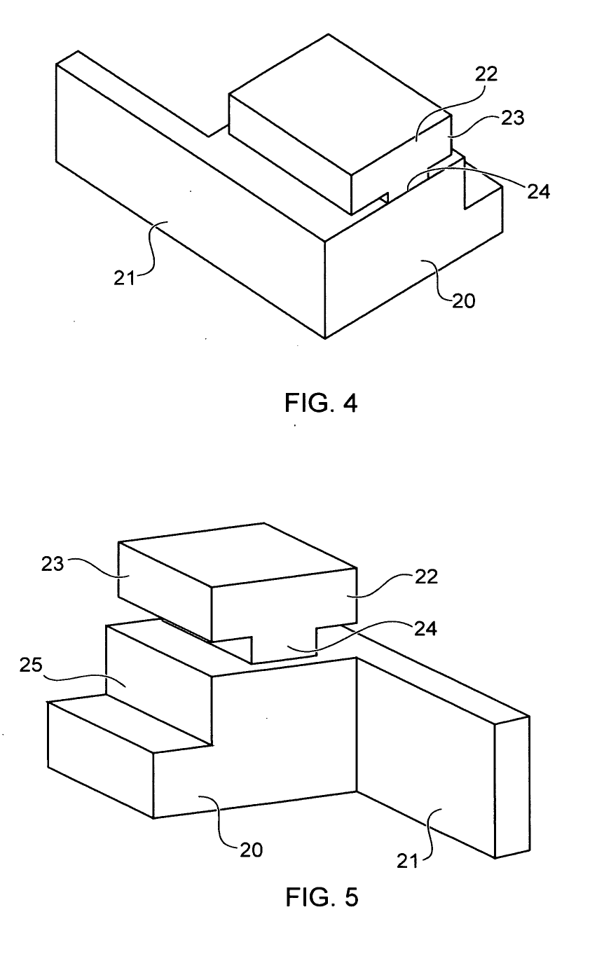

Two pivot locks in the form of blocks 20 are mounted in groove 14 of outer frame 11. As shown in FIGS. 2-5, each pivot block has a leg 21 extending from block 20 and running parallel to groove 14. Leg 21 rests against inner frame 13 of sash 12 and prevents sash 12 from pivoting inward during high winds. The block is made from a stiff, strong material that is made to withstand a large amount of force. A suitable material is aluminum, but other materials are also suitable.

Blocks 20 are kept in place in groove 20 by a T-shaped flange structure 22 that extends below the bottom surface of block 20. Flange structure 22 comprises a neck 24 extending out of the bottom surface of block 20, and two wings 23 extending parallel with the top and bottom surfaces of block 20. Each wing 23 of the flange structure 22 fits underneath a lip 16 of groove 14 to keep block 20 from falling out of groove 14. A cut-out portion 15 is located in each side of outer frame 11 that contains a block 20. Cut-out portion 15 does not have any flanges 16 to keep blocks 20 in place. To remove blocks 20 from window assembly 10, the user simply slides block 20 into cut-out portion 15, and lifts block 20 off of outer frame 11. Blocks 20 are installed in the window through portion 15 as well. This way, the blocks are completely removable, and need only be placed in the window during storm season.

Since blocks 20 are easily slidable within groove 14, blocks 20 do not impede the opening of window sashes 20 by sliding sashes 20. Blocks 20 only serve to prevent inadvertent pivoting of sashes 12 when blocks 20 are placed abutting a leading edge of the sash so that leg 21 runs along a portion of the sash.

Block 20 is preferably configured so that its bottom profile exactly matches the profile of outer frame 11 and groove 14, so that block 20 fits securely within groove 14. Leg 21 is preferably approximately equal to the length of block 20. This provides the optimum combination of strength and security. Leg 21 should be as long as possible to prevent pivoting of sash 21, but still maintain structural integrity with block 20.

Accordingly, while only a few embodiments of the present invention have been shown and described, it is obvious that many changes and modifications may be made thereunto without departing from the spirit and scope of the invention.

What is claimed is:

1. A device for preventing a sliding sash of a window from pivoting out of a window frame, comprising:
a block having a top surface, a bottom surface, a front face, a rear face, a leading end and a trailing end, the bottom surface being configured to fit slidably within a window frame adjacent a sash within the window frame, and the leading end of the block having a leg extending therefrom, such that when the block is positioned in the window frame so that the leading end abuts the window frame, the leg extends along a peripheral edge of the sash and prevents the sash from pivoting out of the window frame.

2. The device according to claim 1, wherein the block is constructed from aluminum.

3. The device according to claim 1, wherein the bottom surface of the block has a flange extending therefrom parallel to the top surface of the block, said flange keeping the block slidably mounted in the window frame when said block is placed in a window frame.

4. A window assembly, comprising:
a window frame having an inner surface with a groove running all around said inner surface;
two sashes slidably mounted in the groove of said window frame, said sashes being offset from one another in said window frame so that the sashes can slide independently of one another; and
at least one pivot lock mounted in the groove adjacent an end surface of one of the sashes, said pivot lock comprising a block having a top surface, a bottom surface, a front face, a rear face, a leading end and a trailing end, the bottom surface being configured to fit slidably within the groove, and the leading end of the block having a leg extending therefrom, the leg extending along a peripheral edge of the sash and preventing the sash from pivoting out of the window frame.

5. The window assembly according to claim 4, wherein there are two pivot locks, each located on opposite sides of the window frame.

6. The window assembly according to claim 5, wherein the groove has a lip extending perpendicular to a longitudinal axis of the groove, and wherein the bottom surface of the block has a flange extending parallel to the top surface of the block, the flange interlocking with the lip to keep the block securely and slidably mounted in the window frame.

7. The window assembly according to claim 6, wherein the groove has an open area with no lip, so that the block can be removed from the window frame by sliding the block to the open area and removing the block from the frame.

8. The window assembly according to claim 5, wherein the frame is installed so that the sashes slide in a horizontal direction.

9. The window assembly according to claim 5, wherein the block is made of aluminum.

10. The window assembly according to claim 5, wherein the leg has a length approximately equal to a length of the block.

11. The window assembly according to claim 5, wherein the bottom surface of the block has a cross-section that corresponds to a cross-section of the groove of the frame.
